(19) United States
(12) Patent Application Publication
(10) Pub. No.: US 2008/0235137 A1
(43) Pub. Date: Sep. 25, 2008

(54) Apparatus and method for the secure distribution of digital content to portable multimedia devices in an unsecured environment

(75) Inventors: Aaron Knoll, Holtsville, NY (US); Jennifer Kelliher, Bellport, NY (US)

Correspondence Address: FELDMAN LAW GROUP PC, 12 E. 41st Street, New York, NY, 10017, US

(73) Assignee: Protocall Technologies

(21) Appl. No.: 11/801,668

(22) Filed: May 10, 2007

Related U.S. Application Data
(60) Provisional application No. 60/799,009, filed on May 10, 2006.

(51) Int. Cl. H04K 1/00

(52) U.S. Cl. 705/51

(57) ABSTRACT

The ability of retail stores to sell digital products through the secure distribution and delivery of digital video and/or audio content directly to a Portable Multimedia Device or a memory module that inserts into a portable media device.

### CROSS-REFERENCE TO RELATED APPLICATIONS

This application is based upon and hereby claims priority to U.S. Provisional Patent Ser. No. 60/799,009 filed May 10, 2006 and entitled APPARATUS AND METHOD FOR THE SECURE DISTRIBUTION OF DIGITAL CONTENT TO PORTABLE MULTIMEDIA DEVICES IN AN UNSECURED ENVIRONMENT, hereby incorporated by reference.

### FIELD OF THE INVENTION

This invention relates generally to an apparatus and method for the secure distribution and delivery of digital video and/or audio content directly to a Portable Multimedia Device or a memory module that inserts into a portable media device.

### BACKGROUND

Due to the rapid adoption of portable media devices such as the Apple iPod™ there is a need for traditional retail stores to be able to compete with Internet-based digital content download services. Currently the only way a consumer can purchase content for their Portable Multimedia Device (PMD) is to purchase the content from a centralized Internet Web Site and transfer the data to their PMD. Traditional retailers, however, are left out of this transaction as the sales takes place between the consumer and the Internet Web Site.

In order to capture these lost sales, there is a need for a device that can be located at the retail store location that provides the ability to securely search, purchase and ultimately transfer content to the users PMD.

### SUMMARY OF THE INVENTION

A principal object of the present invention is to create an apparatus and method of facilitating the distribution of digital products in a secure fashion.

Another object of the present invention is to create an apparatus and method for secure transmission of digital products to a portable media device.

Another object of the present invention is to create an end-to-end ordering solution to facilitate the purchase of digital multimedia content.

Another object of the present invention is to create a method for downloading content from the internet to a computer that was purchased via remote kiosk.

Another object of the present invention is to create a secure infrastructure to protect the intellectual property rights of the content provider.

Another object of the present invention is to create an additional revenue stream for the Retail Store Locations.

Another object of the present invention is to utilize advanced cryptography to inhibit piracy.

It is intended that any other advantages and objects of the present invention that become apparent or obvious from the detailed description or illustrations contained herein are within the scope of the present invention.

### BRIEF DESCRIPTION OF THE FIGURES

FIG. 1 shows a remote kiosk, high speed network connection, and a Network Operations Center.

FIG. 2 shows a diagram of a consumer wishing to purchase digital content for use, utilizing the User Interface of the Remote Kiosk.

### DETAILED DESCRIPTION OF THE INVENTION

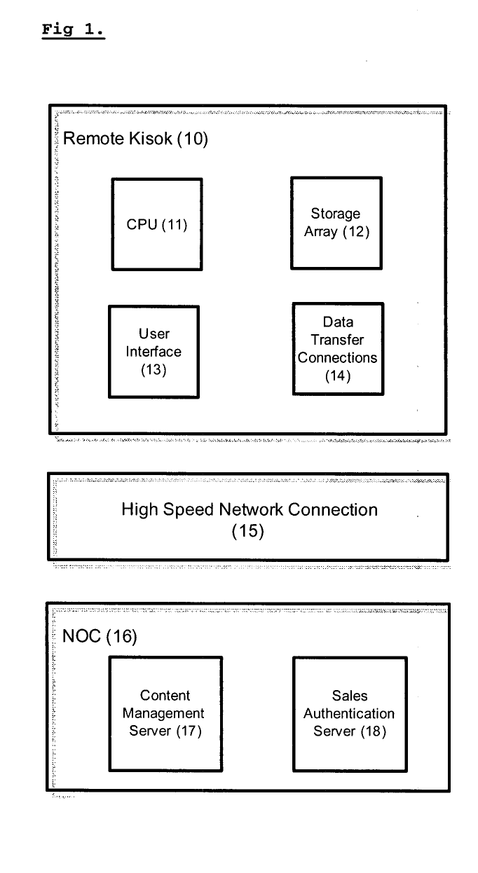

As shown in FIG. 1, the present invention consists of three parts:
1. A remote kiosk 10 that includes:
   a. Central Processing Unit 11
   b. Large data storage array 12
   Each product stored on the Large Storage Array 12 is stored in an encrypted form which in inaccessible unless a Sales Authorization Server 18 authenticates the order.
   c. User interface 13
   This can be touch screen interface, a mouse/keyboard driven interface, a voice-activated interface, or any other machine driven interface. Each Kiosk 10 can have one or many user interface connectors in order to facilitate multiple concurrent orders.
   d. PMD data transfer connections 14
   These are wired or wireless connections that enable data transfer to the PMD from the Remote Kiosk 10
2. High speed network connection 15
The connection can be either a dedicated connection such as a private frame relay or dedicated satellite connection; or a public internet connection.
3. Network Operations Center 16
   a. Content Management Server 17
   Manages transfer and storage of the digital content
   b. Sales Authorization Server 18

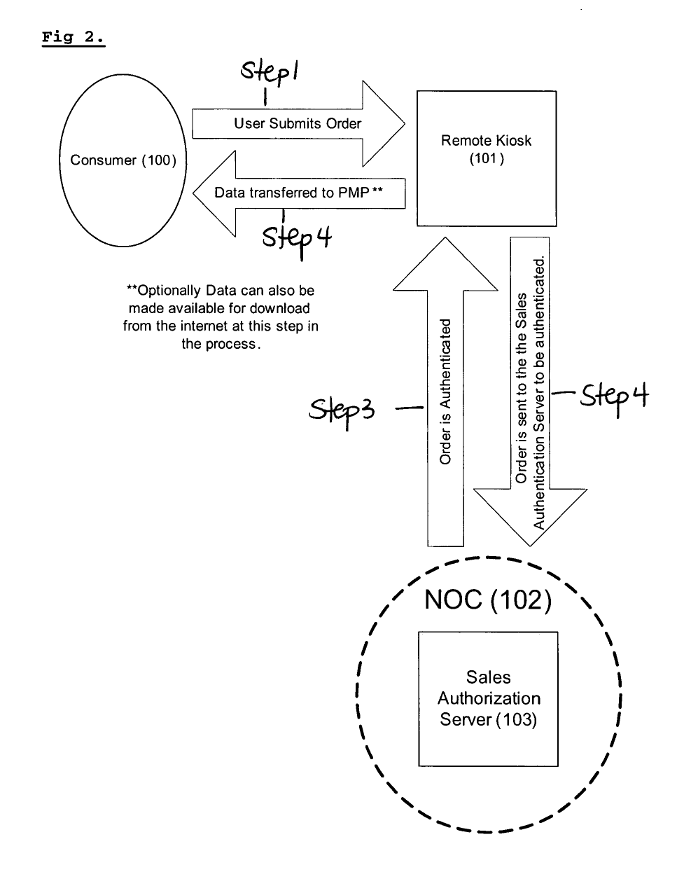

For example, as shown in FIG. 2, a consumer 100, wishing to purchase digital content for use on their PMD utilizes the User Interface 13 of the Remote Kiosk 101 to download the product and provides payment (Step 1). The Remote Kiosk 101, utilizing the High speed network connection 15, contacts The Network Operations Center 102 and authorizes the transaction via the Sales Authorization Server 103 (Step 2). Once the sale has been authorized (Step 3), the Consumer 100 attaches their PMD to the PMD data transfer connection cables 14 or enables any wireless transfer protocols that are necessary and the content is transferred to their device (Step 4). The content could also be available for download to consumer's home Computer at a later date. The Remote Kiosk verifies that the content has been transferred and the transaction is complete.

A full log of the transaction is kept at the Network Operations Center 102. Additional security measures such as proprietary Digital Rights Management (DRM), digital watermarking, or other anti-piracy techniques can be added to the digital product at the point of sale.

It is further intended that any other embodiments of the present invention that result from any changes in application or method of use or operation, method of manufacture, shape, size, or material which are not specified within the detailed written description or illustrations contained herein yet are considered apparent or obvious to one skilled in the art are within the scope of the present invention.

What is claimed is:

1. A method for purchasing digital content for use on a Portable Multimedia Device (PMD) comprising the steps of (1) utilizing a user interface whereby said user interface is located in a retail store; (2) downloading said digital content onto said PMD; and (3) providing payment for said digital content.

2. The method of claim 1 wherein said retail store utilizes a high speed network connection to contact a network operations center.

3. The method of claim 1 wherein said retail store authorizes said purchase of said digital content via a sales authorization server.

4. The method of claim 1 further comprising the steps of (1) enabling data transfer protocols to said PMD; and (2) downloading said digital content to said PMD.

5. The method of claim 1 wherein said retail store verifies said download of said digital content.

6. The method of claim 1 wherein said retail store verifies said purchase of said digital content is complete.

7. The method of claim 1 wherein a log of said download and said purchase is kept at a network operations center.
